(19) United States
(12) Patent Application Publication
(10) Pub. No.: US 2008/0262904 A1
(43) Pub. Date: Oct. 23, 2008

(54) Method and system for automatically monitoring contact center performance

(76) Inventors: Kelly Conway, Lake Bluff, IL (US); David Gustafson, Lake Forest, IL (US); Douglas Brown, Austin, TX (US); Christopher Danson, Austin, TX (US)

Correspondence Address: MCDERMOTT, WILL & EMERY LLP, 227 WEST MONROE STREET, SUITE 4400, CHICAGO, IL, 60606-5096, US

(21) Appl. No.: 12/079,827

(22) Filed: Mar. 28, 2008

Related U.S. Application Data
(60) Provisional application No. 60/921,110, filed on Mar. 30, 2007.

(51) Int. Cl. G06Q 10/00

(52) U.S. Cl. 705/11

(57) ABSTRACT

A method and system for automatically monitoring a performance area for a contact center is provided. The method is implemented by a computer readable medium having a plurality of code segments. The method includes the step of identifying a performance area including one or more of the following: human activity-based performance, caller dissatisfaction performance, problem call performance, customer service representative performance, business process performance, self service performance and peer comparison performance. An input transmission of a threshold for the identified performance area is received. Analytics generated for each of a plurality of interactions are received. For each of the plurality of interactions, analytics are selected that correspond to the identified performance area. An indicator value is assigned to the selected analytics for the identified performance area. The indicator value is compared to the threshold and performance data is generated therefrom.

### CROSS-REFERENCE TO RELATED APPLICATIONS

The present invention claims priority to U.S. Provisional Patent Application No. 60/921,110, filed Mar. 30, 2007.

### TECHNICAL FIELD

The present invention relates to a method and system for automatically monitoring identified performance areas for a contact center, and more particularly, for aggregating and analyzing analytics relating to interactions with a contact center and generating contact center performance data therefrom.

### BACKGROUND OF THE INVENTION

It is known to utilize telephone call centers (“contact centers”) to facilitate the receipt and response of telephone calls or other interactions between a customer and an agent or a customer service representative (CSR). Generally, a customer is in contact with a CSR who is responsible for answering the customer's inquiries and directing the customer to the appropriate individual, department, information source, or service as required to satisfy the customer's needs. It is well known to monitor interactions between a customer and a CSR and to generate and collect a variety of analytics from the monitored interactions.

Historically analytics derived from an interaction have been generated and collected in an unstructured format that required for manual, human analysis of the resultant data. In many instances, it may also be desirable to analyze the collected and generated analytics for the interactions received by a contact center on a monthly, weekly or even daily basis. If performed manually, such frequent and timely analyses of the analytics would be prohibitive. Particularly, due to the volume and variety of analytics generated, a manual, human analysis can be costly, time consuming, and inconsistent as a result of variability in individual opinions, biases and quality of the human analyzer.

Although, there exist prior art systems and methods for monitoring processes of an information technology system, such a system and method has inherent limitations that make such a system inapplicable to contact center environments. For example, monitoring the process of an information technology system focuses on system performance (e.g. how servers perform or the speed of microprocessors), analytics that are not easily adapted to human performance analytics.

Thus, there is a need in customer relationship management (“CRM”) for an automated monitoring system to monitor identified performance areas and track the analytics compared to performance thresholds on a continuing basis. In addition, it would be useful for automatic alerts and action tickets to be generated when the monitored analytics exceed certain performance thresholds.

The present invention is provided to solve the problems discussed above and other problems, and to provide advantages and aspects not previously provided. A full discussion of the features and advantages of the present invention is deferred to the following detailed description, which proceeds with reference to the accompanying drawings.

### SUMMARY OF THE INVENTION

According to the present invention, a computer program for automatically monitoring an identified performance area for a contact center is provided. The computer program is embodied on a computer readable storage medium adapted to control a computer. The computer program comprises a plurality of code segments for performing the task. In particular, a performance area comprising one or more of the following: human activity-based performance, caller dissatisfaction performance, problem call performance, customer service representative performance, business process performance, self service performance and peer comparison performance is identified.

An input transmission of a threshold for the identified performance area is received. Additionally, analytics generated for each of a plurality of interactions are received. For each of the interactions, analytics are selected that correspond to the identified performance area are selected from the received analytics. For each of the plurality of interactions, an indicator value, is assigned to the selected analytics for the identified performance area. The indicator value is compared to the threshold and performance data is generated therefrom for each of the interactions. Also, an alert is generated when the assigned indicator values is equal to or exceeds the threshold.

According to another aspect of the invention, a computer readable medium for automatically monitoring an identified performance area of a contact center on a macro scale is provided. Again, the computer program is embodied on a computer readable storage medium adapted to control a computer. The computer program comprises a plurality of code segments for performing the task. In particular, a desired performance area is identified. The performance area will be one or more of the following: human activity-based performance, caller dissatisfaction performance, problem call performance, customer service representative performance, business process performance, self service performance and peer comparison performance.

An input transmission of a first threshold for the identified performance area is received. Analytics are received in the form of either or both voice data and IVR inputs are generated for each of a plurality of interactions received by a contact center. For each of the plurality of interactions, the analytics that correspond to the identified performance area are selected. For each of the plurality of interactions, a first indicator value is assigned to the selected analytics for the identified performance area. The first indicator value is compared to the first threshold, and performance data is generated therefrom for each of the plurality of interactions.

The performance data for at least two of the plurality of interactions is aggregated, and a macro indicator value is assigned to the aggregated performance data for an identified performance area. An input transmission of a macro threshold for the aggregated performance data is received. The macro indicator value for the aggregated performance data is compared to the macro threshold and macro performance data is generated therefrom. Also, a macro alert is generated when the assigned macro indicator value is equal to or exceeds the macro.

According to still another aspect of the invention, the input threshold is dynamically adjusted based on the generated performance data.

According to yet another aspect of the invention, automatically monitoring a performance area for a contact center further includes instructions (e.g., a code segment or logic) for analyzing either or both the performance data and the generated alert for at least two of the plurality of interactions and generating trend data. In addition, either or both a trend data report and a graphical user interface adapted to display the trend data is generated.

According to another aspect of the invention, assessment data based on the trend data is generated. The generated assessment data includes either or both an assessment data report and a graphical user interface adapted to display the assessment data.

According to another aspect of the invention, an action ticket is generated when an alert is generated.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a block diagram of a contact center in accordance with the present invention;

FIG. 2 is a block diagram of the architecture for a telephonic communication system according to the present invention;

FIG. 3 is a block diagram of a computer used in connection with the present invention;

FIG. 4 is a block diagram of a telephonic communication system with a multi-port PSTN module according to the present invention;

FIG. 5 is a flow chart illustrating the process of automatically monitoring an identified performance area for a contact center in accordance with the present invention;

FIG. 6 is a graphical representation of the components for automatically monitoring an identified performance area for a contact center in accordance with the present invention; and

FIG. 7 is a graphical representation of a generated action ticket in accordance with the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

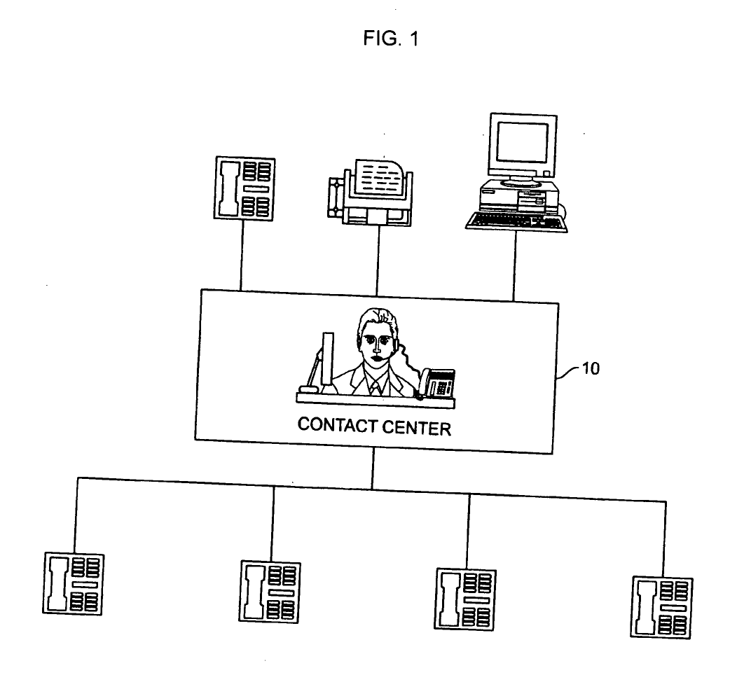

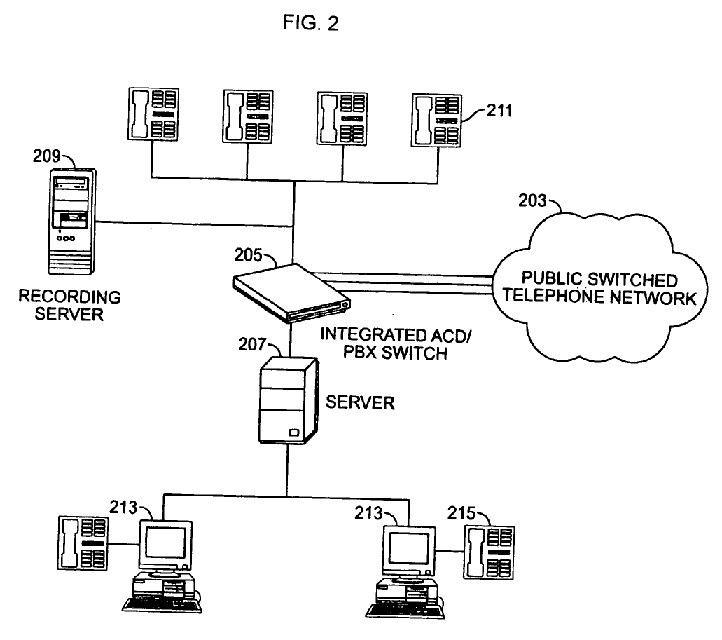

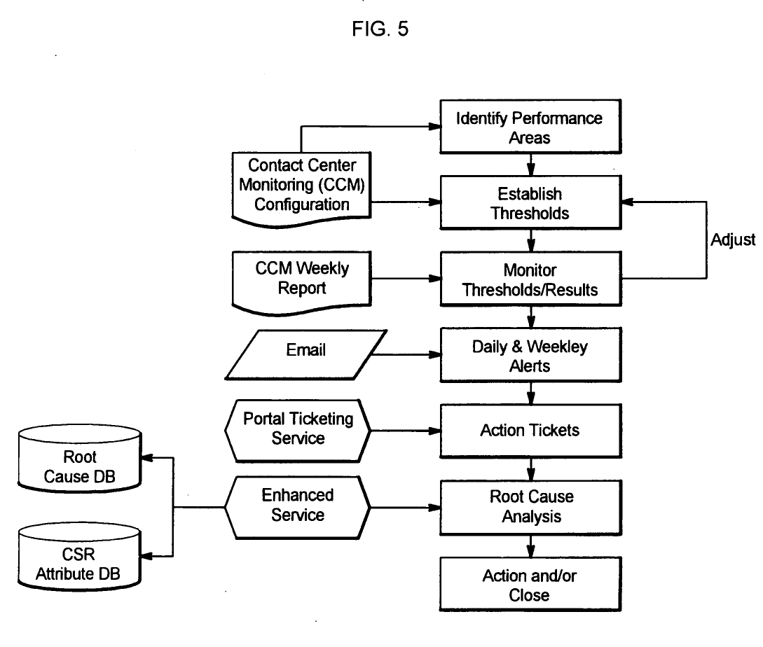

Referring to FIGS. 1-7, a method and system for automatically monitoring identified performance areas for a contact center 10 is provided. A “contact center” as used herein can include any facility or system server suitable for receiving and recording electronic interactions from customers. Such interactions can include, for example, telephone calls, facsimile transmissions, e-mails, web interactions, voice-over IP (“VoIP”) and video. It is contemplated that these interactions may be transmitted by and through any type of telecommunication device and over any medium suitable for carrying data. For example, the interactions may be transmitted by or through telephone lines, cable or wireless communications. As shown in FIG. 1, the contact center 10 of the present invention facilitates interactions that occur between a customer and a contact center during fulfillment of a customer transaction.

According to one embodiment of the invention, the system used in connection with the present method includes an interactive voice response (IVR) system, a telephone switch or switching system, a routing server and a recording server. Now will be described in more specific terms, the computer hardware associated with operating the computer program that may be used in connection with the present invention.

Process descriptions or blocks in figures should be understood as representing modules, segments, or portions of code which include one or more executable instruction for implementing specific logical functions or steps in the process. Alternate implementations are included within the scope of the embodiments of the present invention in which functions may be executed out of order from that shown or discussed, including substantially concurrently or in reverse order, depending on the functionality involved, as would be understood by those having ordinary skill in the art.

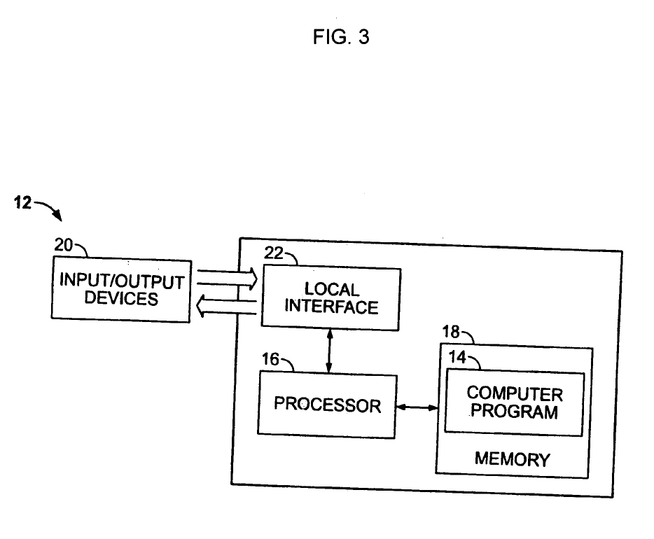

FIG. 3 is a block diagram of a computer or server 12. For purposes of understanding the hardware as described herein, the terms “computer” and “server” have identical meanings and are interchangeably used. Computer 12 includes control system 14. The control system 14 of the invention can be implemented in software (e.g., firmware), hardware, or a combination thereof. In a currently contemplated preferred embodiment, the control system 14 is implemented as an executable program in software, and is executed by one or more special or general purpose digital computer(s), such as a personal computer (PC; IBM-compatible, Apple-compatible, or otherwise), personal digital assistant, workstation, minicomputer, or mainframe computer. An example of a general purpose computer that can implement the control system 14 of the present invention is shown in FIG. 3. The control system 14 may reside in, or have portions residing in, any computer such as, but not limited to, a general purpose personal computer. Therefore, computer 12 of FIG. 3 may be representative of any computer in which the control system 14 resides or partially resides.

Generally, in terms of hardware architecture, as shown in FIG. 3, the computer 12 includes a processor 16, memory 18, and one or more input and/or output (I/O) devices 20 (or peripherals) that are communicatively coupled via a local interface 22. The local interface 22 can be, for example, but not limited to, one or more buses or other wired or wireless connections, as is known in the art. The local interface 22 may have additional elements, which are omitted for simplicity, such as controllers, buffers (caches), drivers, repeaters, and receivers, to enable communications. Further, the local interface may include address, control, and/or data connections to enable appropriate communications among the other computer components.

The processor 16 is a hardware device for executing software, particularly software stored in memory 18. The processor 16 can be any custom made or commercially available processor, a central processing unit (CPU), an auxiliary processor among several processors associated with the computer 12, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×8 or Pentium series microprocessor from Intel Corporation, a PowerPC microprocessor from IBM, a Sparc microprocessor from Sun Microsystems, Inc., a 8xxx series microprocessor from Motorola Corporation, an Intel Xeon (Single and Dual Core), or an Intel Xeon Processor MP (Single and Dual Core).

The memory 18 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 18 may incorporate electronic, magnetic, optical, and/or other types of storage media. The memory 18 can have a distributed architecture where various components are situated remote from one another, but can be accessed by the processor 16. The software in memory 18 may include one or more separate programs, each of which comprises an ordered listing of executable instructions for implementing logical functions. In the example of FIG. 3, the software in the memory 18 includes the control system 14 in accordance with the present invention and a suitable operating system (O/S) 24. A non-exhaustive list of examples of suitable commercially available operating systems 24 is as follows: (a) a Windows operating system available from Microsoft Corporation, including but not limited to, Microsoft Vista and Windows Mobile Client; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system 24 essentially controls the execution of other computer programs, such as the control system 14, and provides scheduling, input-output control, file and data management, memory management, and communication control and related services.

The control system 14 may be a source program, executable program (object code), script, or any other entity comprising a set of instructions to be performed. When a source program, the program needs to be translated via a compiler, assembler, interpreter, or the like, which may or may not be included within the memory 18, so as to operate properly in connection with the O/S 24. Furthermore, the control system 14 can be written as (a) an object oriented programming language, which has classes of data and methods, or (b) a procedure programming language, which has routines, subroutines, and/or functions, for example but not limited to, C, C++, C# (C Sharp), Pascal, Basic, Fortran, Cobol, Perl, Java, Ada, and PHP. In one embodiment, the control system 14 is written in C++. The I/O devices 20 may include input devices, for example but not limited to, a keyboard, mouse, scanner, microphone, touch screens, interfaces for various medical devices, bar code readers, stylus, laser readers, radio-frequency device readers, etc. Furthermore, the I/O devices 20 may also include output devices, for example but not limited to, a printer, bar code printers, displays, etc. Finally, the I/O devices 20 may further include devices that communicate both inputs and outputs, for instance but not limited to, a modulator/demodulator (a modem for accessing another device, system, or network), a radio frequency (RF) or other transceiver, a telephonic interface, a bridge, a router, etc.

If the computer 12 is a PC, workstation, PDA, or the like, the software in the memory 18 may further include a basic input output system (BIOS) (not shown in FIG. 3). The BIOS is a set of software routines that initialize and test hardware at startup, start the O/S 24, and support the transfer of data among the hardware devices. The BIOS is stored in ROM so that the BIOS can be executed when the computer 12 is activated. When the computer 12 is in operation, the processor 16 is configured to execute software stored within the memory 18, to communicate data to and from the memory 18, and to generally control operations of the computer 12 pursuant to the software. The control system 14 and the O/S 24, in whole or in part, but typically the latter, are read by the processor 16, perhaps buffered within the processor 16, and then executed.

When the control system 14 is implemented in software, as is shown in FIG. 3, it should be noted that the control system 14 can be stored on any computer readable medium for use by or in connection with any computer related system or method. In the context of this document, a “computer-readable medium” can be any medium that can store, communicate, propagate, or transport the program for use by or in connection with the instruction execution system, apparatus, or device. The computer readable medium can be for example, but is not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). The control system 14 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In another embodiment, where the control system 14 is implemented in hardware, the control system 14 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

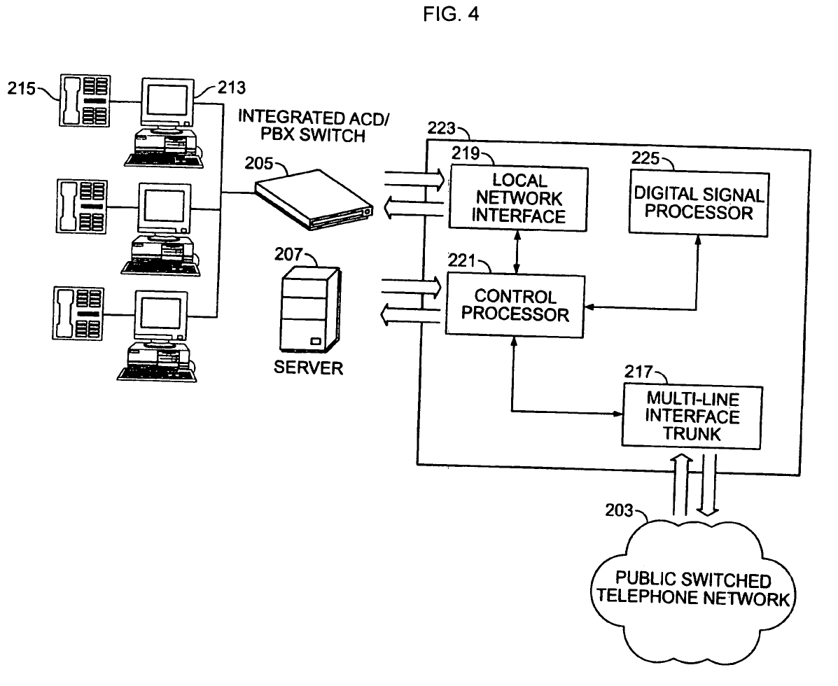

Many interactions, or at least a portion of interactions, with a contact center are embodied in a telephonic communication. As may be seen in FIG. 4, a customer sending a telephonic communication can access a contact center 10 directly through the public switched telephone network (PSTN) 203. Alternatively, the telephonic signal can be distributed through a private branch exchange (PBX), having a public switched telephone network (PSTN) 203 connected to the PBX through a PBX switch 205. The PBX switch 205 provides an interface between the PSTN 203 and a local network. Preferably, the interface is controlled by software stored on a telephony server 207 coupled to the PBX switch 205. The PBX switch 205, using interface software, connects trunk and line station interfaces of the public switch telephone network 203 to stations of a local network or other peripheral devices contemplated by one skilled in the art. Further, in another embodiment, the PBX switch may be integrated within a telephony server 207. The stations may include various types of communication devices connected to the network, including the telephony server 207, a recording server 209, telephone stations 211, and client personal computers 213 equipped with telephone stations 215. The local network may further include fax machines and modems and other devices.

According to the present invention, computer telephony integration (“CTI”) technology is provided. In a preferred embodiment discussed herein, CTI resides on a telephony server 207. However, it will be understood by those skilled in the art that CTI can reside on its own server or at other hardware described herein. Generally, in terms of hardware architecture, the telephony server 207 includes a processor, memory, and one or more input and/or output (I/O) devices (or peripherals) that are communicatively coupled via a local interface. The processor can be any custom-made or commercially available processor, a central processing unit (CPU), an auxiliary processor among several processors associated with the telephony server 207, a semiconductor based microprocessor (in the form of a microchip or chip set), a macroprocessor, or generally any device for executing software instructions. The memory of the telephony server 207 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). The telephony server 207 may further include a keyboard and a mouse for control purposes, and an attached graphic monitor for observation of software operation. It will be understood that the telephony server may include standard CTI technology, such as that sold by Cisco, Avaya, Genesys or other provider of CTI providers.

According to one embodiment, the telephony server 207 also incorporates PBX control software to control the initiation and termination of connections between stations and via outside trunk connections to the PSTN 203. In addition, the software may monitor the status of all telephone stations 211 in real-time on the network and may be capable of responding to telephony events to provide traditional telephone service. This may include the control and generation of the conventional signaling tones such as dial tones, busy tones, ring back tones, as well as the connection and termination of media streams between telephones on the local network. Further, the PBX control software may use a multi-port module 223 and PCs to implement standard PBX functions such as the initiation and termination of telephone calls, either across the network or to outside trunk lines, the ability to put calls on hold, to transfer, park and pick up calls, to conference multiple callers, and to provide caller ID information.

It is known in the art that “cradle-to-grave” recording may be used to record all information related to a particular telephone call from the time the call enters the contact center to the later of: the caller hanging up or the agent completing the transaction. The oral call information will be stored in a voice data server. All of the interactions during the call are recorded, including interaction with an IVR system, time spent on hold, data keyed through the caller's key pad, conversations with the agent, and screens displayed by the agent at his/her station during the transaction. It is further known that additional voice data may be stored in the voice data, including but not limited to, call type data, distress data, behavioral assessment data, call timing data, customer response data and customer profile data. The voice data when stored in the voice database will be stored in such a known method such that the data is associated with a interaction identifier. Associating the conversation data with a interaction identifier will allow for the data to be easily accessed later.

According to one embodiment of the present invention, interactions with the IVR system will be stored in an interactive response database. The information stored can include the actual audio conversation and data associated with events occurring while the interaction is in IVR. For example, the stored information can include voice logs (i.e., voice recordings), buttons pushed by a customer during the interaction, the location of where the customer is transferred in response to the buttons pushed, queries prompted by the IVR, call type data, distress data, call timing data, customer response data, customer profile data, customer log data, or any other information that may be mined or harvested from an IVR interaction between a customer and a call center. The information will be stored in the interactive response database in a method such that the data may be easily associated with a interaction identifier. The association of interactive response data with an interaction identifier facilitates subsequent ease of access to the data.

Further, the recording server 209 may be used to record an Internet based customer inquiry session. The data between a customer and a web system is stored in a web interaction database. All of the responses and corresponding actions taken are recorded, including timing of actions, data entered and screens displayed to the customer. It is also contemplated that additional information such as inquiry type data, web timing data, customer response data, customer profile data and customer log data are also stored in the web interaction database. The web interaction data, when stored in the web interaction database is associated with an interaction identifier, allowing the data to be accessed at a later time.

According to another aspect of the present invention, a computer program for automatically monitoring a performance area for a contact center is provided. The computer program is embodied on a computer readable storage medium adapted to control a computer as described above. As further discussed above, the computer program comprises a plurality of code segments for performing the task.

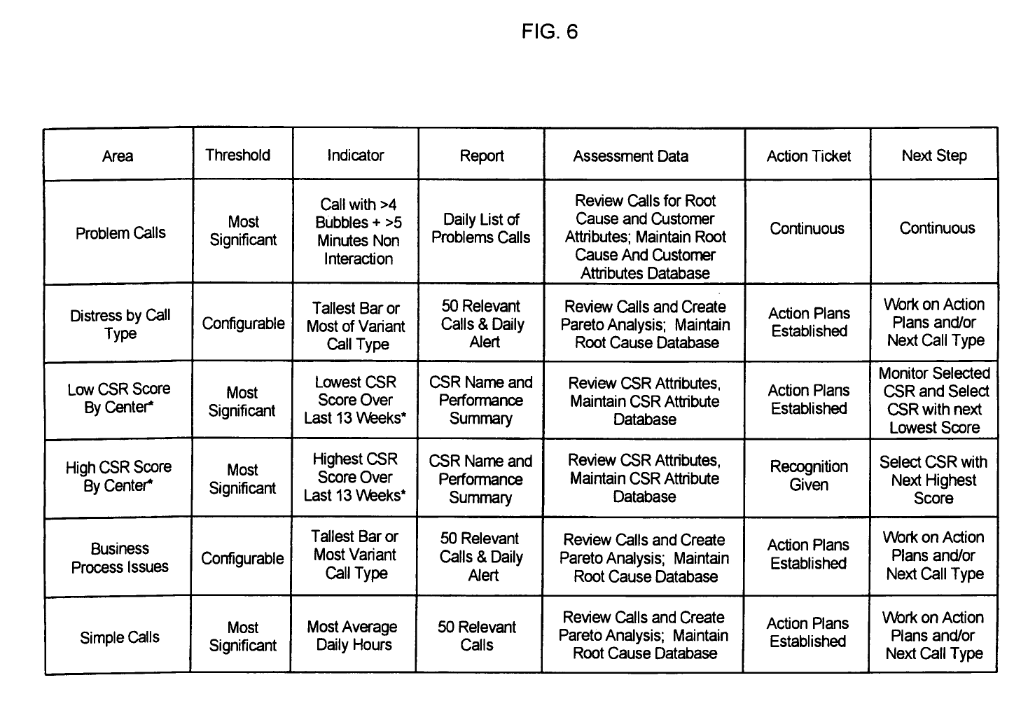

As shown in FIG. 6, the computer program of the present invention is configured to identify one or more performance areas that will be the subject of the analysis. Preferably, the identified performance areas will include one or more of the following: a human activity-based performance, caller dissatisfaction performance, problem call performance, customer service representative performance, business process performance, self service performance and peer comparison performance. A chart is provided below that identifies the preferred performance areas and associated analytic characteristics:

Performance Areas:

| | |
|---|---|
| Human activity- | Analyzes the effectiveness of an agent's use |
| based performance | of his time during and after an interaction. |
| Caller dissatis- | Analyzes distress events occurring during an |
| faction performance | interaction. |
| Problem call | Analyzes interactions with an usual |
| performance | frequency or quality of distress events. |
| Customer Service | Analyzes the effectiveness of a CSR's |
| Representative (“CSR”) | performance during an interaction. The |
| Performance | criteria used to analyze a CSR's performance |
| | are described in U.S. Patent Application No. |
| | XX/XXX,XXX (Attorney Docket No. |
| | 077145-0022), which is incorporated herein |
| | by reference. |
| Business process | Analyzes the effectiveness of business |
| performance | processes performed during an interaction. |
| | The criteria used to measure business process |
| | performance are described in U.S. Patent |
| | Application No. XX/XXX,XXX (Attorney |
| | Docket No. 077145-0025), which is |
| | incorporated herein by reference. |
| Simple call | Analyzes the effectiveness of interactions |
| performance | that are completely automated or have the |
| | potential to be automated. |
| Peer comparison | Analyzes peer performance, and compares it |
| performance | with the performance of the subject contact |
| | center. It is understood that peer can be |
| | another contact center, which is part of the |
| | same enterprise as the subject contact center, |
| | but in a different location, or a contact center |
| | in the same industry as the subject contact |
| | center. |

Thus, the identified performance areas generally are meant to correspond with various functions and activities occurring at a contact center. Accordingly, the performance areas are selected to monitor the effectiveness of the contact center in executing the corresponding functions and activities. It will be understood that the names or categories of performance areas described herein are in no way meant to limit the scope of the present invention. Instead, the names and categories are provided by way of example. It is contemplated that the identified performance areas may be named, categorized and identified based on the business needs, objectives and standards or a particular use.

According to the present invention, the computer program is also input with a first threshold value corresponding to an identified performance area or set of performance areas. It will be understood that the threshold can be input by known input devices and methods. For example, the input device can be a keyboard, a touch screen, a drop down menu associated with a graphical user interface, or any other suitable devices or methods for inputting data into a computer program.

Typically, the threshold represents an indicative score or value reflective of one or more target criteria for the operation of a contact center. Preferably, the thresholds will correspond to one of the following criteria: a target performance level, a minimum performance level, an industry performance baseline, a regulated standard of performance or any other suitable target criteria. For example, the threshold can be representative of an occurrence or non-occurrence of an identified event during an interaction. As another example, the threshold can be representative of a frequency rate at which an identified event occurs during an interaction. It is also contemplated by the present invention, that more than one threshold can be input and received for a single performance area.

In one embodiment of the present invention, the input threshold may be automatically generated or adjusted (i.e., a dynamic threshold) based, for example, on previously generated performance data. For example, a dynamic threshold can be configured to automatically adjust when a threshold is exceeded (e.g., the threshold can be automatically adjusted to a threshold 5% greater than the prior threshold score). Alternatively, a dynamic threshold can be adjusted in response to a change in time period or frame. For example, a dynamic threshold score may configured to automatically adjust by 5% relative to the threshold of the prior quarter. It will also be understood that such dynamic thresholds can be configured to automatically adjust in accordance with any predetermined criteria.

The computer program is configured to receive analytics generated for interactions received by a contact center. The analytics can be retrieved from a database configured to store analytics associated with contact center interactions. It will be understood by those of skill that such a database can be a relational database that is configured to associate analytics with corresponding customer or interaction identifiers. Alternatively, the analytics can be generated in real time during the occurrence of an interaction. Preferably the interactions are based upon one or more of the following data types: voice data, agent call activity data, customer call activity data, and context data. The analytics generated from analyzing each data type are summarized in the chart included herein and described in greater detail in U.S. patent application Ser. No. 11/131,486 and U.S. patent application Ser. No. 11/131,850

| Data Type | Analytics generated |
|---|---|
| Voice data | Behavioral assessment data |
| | Distress assessment data |
| | Phone event assessment data |
| Agent call activity data | Incremental data relating to the length of |
| | time the agent put the customer on hold |
| | The number of times the agent put the |
| | customer on hold |
| | The number of transfers associated with |
| | the call |
| | The entire time spent on the call |
| | Notes the agent made about the |
| | interaction |
| | Time agent spent completing the |
| | interaction |
| | Follow-up activity with the customer |
| | Screen analytics and desktop recording |
| | data |
| Customer call activity data | Customer's interaction with an IVR |
| | system or other data keyed through the |
| | caller's key pad |
| Context Data | Customer history data |
| | Human resources data associated with a |
| | CSR |

Additionally, the received analytics preferably include CSR performance data and business process analytics generated in accordance with the methods and systems as set forth in U.S. patent application Ser. No. XX/XXX,XXXX (Attorney Docket No. 077145-0022), and U.S. application Ser. No. XX/XXX,XXXX (Attorney Docket No. 077145-0022) (both of which are incorporated herein by reference). It will be understood by those of skill that the analytics generated from the data types described are non-exhaustive.

For each of the interactions to be analyzed, the computer program of the present invention selects the analytics that correspond to the identified performance area. In other words the computer program sorts and correlates the appropriate analytics with the selected performance area. Preferably, the analytics corresponding to an identified performance area will be common to an industry. However, it is understood that the analytics selected to correspond to an identified performance area, may be defined by an individual contact center or group of contact centers, by regulatory standards or other indices. For example, if a contact center identifies CSR Performance as a performance area to monitor, then the selected analytics corresponding to the identified performance area can include: behavioral assessment data, distress assessment data, and phone event assessment data.

Once the computer program of the present invention selects the appropriate analytics, the computer program assigns a first indicator value to the selected analytics for the identified performance area. The indicator value is preferably a score that can be based upon the occurrence of an event, the frequency of an occurrence of an event, or any other value suitable for quantifying the selected analytics. The first indicator value is then compared to the first threshold. From the comparison, the computer program is configured to generate performance data for each of the interactions. Preferably, the performance data includes a full or partial analysis of the comparison of the indicator value to the threshold. It is contemplated that the resulting analysis will be displayed via a graphical user interface viewable on a display, or in the form of a report output to a known output device.

In one embodiment of the present invention, an alert is generated when the assigned indicator value is equal to or exceeds the received threshold. More preferably, the alert is generated when the indicator value exceeds the threshold by a predetermined amount. The rules for determining when an alert should be generated can be determined based on the individual parameters established by a particular contact center. Alternatively, the alert threshold may be a function of an industry baseline, a regulated standard or any other suitable criteria. For example, the monitoring system can be configured to generate an alert only when the threshold is exceeded by 10%. Alternative embodiments for generating an alert include, but are not limited to, generating an alert when the indicator value varies from the entered threshold by a predetermined percentage, or generating an alert every time a predetermined number of received interactions exceeds the selected threshold. In a preferred embodiment, the alert comprises an electronic notification sent to a pre-designated recipient or recipients. Alternatively, the alert can be a web site icon or indicator, or other suitable electronic or manual notification mechanisms know to those of skill in the art.

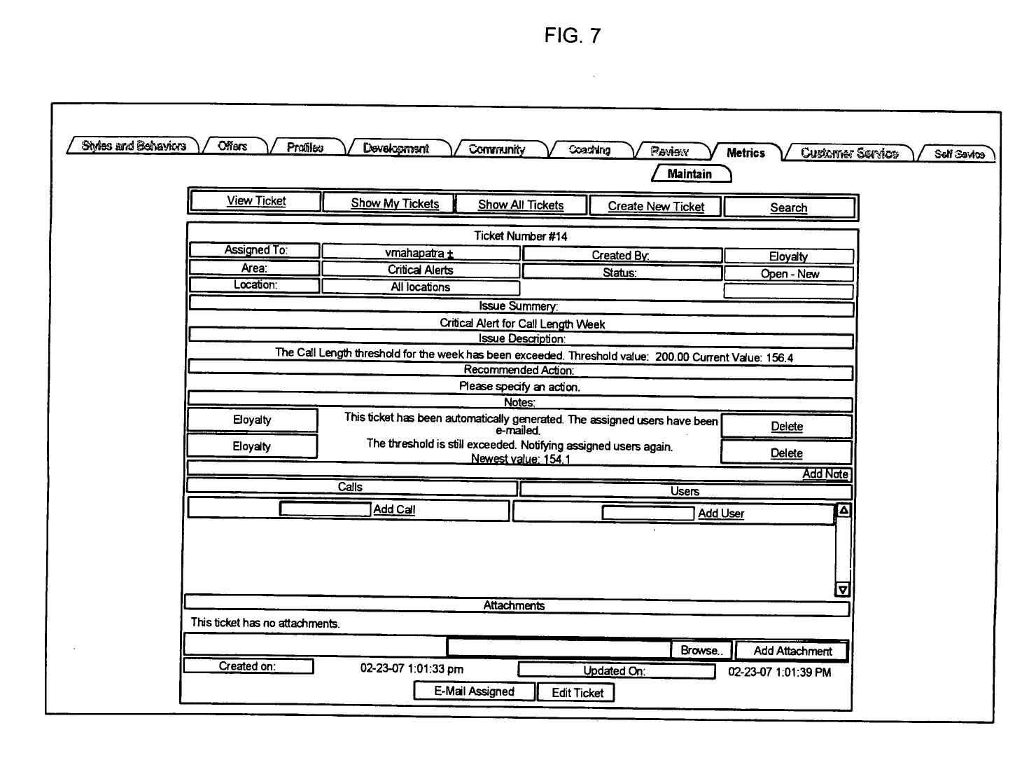

The computer program, according one embodiment of the present invention shown in FIG. 7 is configured to generate an action ticket when an alert is generated. It is contemplated that the action ticket and alert may be generated contemporaneously or at different times and still be within the scope of the present invention. In one preferred embodiment, the action ticket is generated and displayed as a viewable image via graphical user interface (“GUI”). Alternatively, the action ticket can be posted to a website, included as an email or generated as a physical hard copy print out.

Although data concerning the effectiveness of contact center performance vis-a-vis individual interactions are useful, often it is helpful to analyze trends and progress resulting from an analysis of an aggregation of interactions. Accordingly, in one embodiment of the present invention, one or more of the outputs is analyzed for at least two interactions. Preferably either or both the generated performance data and the generated alert is analyzed to generate trend data. Thus, the computer program enables a contact center to view trends established by an aggregate of interactions with the contact center. Also, according to one embodiment, the computer program is configured to generate assessment data based on the trends.

For example, the present system can be configured to aggregate all the alerts generated for a contact center on a weekly basis. The aggregated alerts can be mined for common attributes and generate trend data. For example, a data trend could show: 10 alerts were generated due to low CSR performance, 15 alerts were generated due to a high volume of problems calls. It is further contemplated that either or both a hard copy report illustrating trend data, and a output viewable via a GUI can be generated by the present computer program. Additionally, the output may be in the form of a graphic representation of each alert generated for the interactions received by a contact center for an identified time period; as well as the reason the alerts were generated.

Further, assessment data is generated from an enhanced assessment of the resultant trend data. More particularly, assessment data according to the present invention is a root cause analysis which determines the underlying factors driving the trends reflected in the trend data. Accordingly assessment data is useful in targeting the causation of trends, and developing potential solutions based on the business parameters of the contact center.

According to one embodiment of the invention, the interactions received by a contact center are monitored in the identified performance area on a macro scale. This monitoring may occur instead of, or in addition to, monitoring individual interactions. For example, it may be desirable to monitor performance of a contact center for the week, month, quarter, year, or other discrete time period. Accordingly, it may be desirable to establish thresholds to reflect the expectations of the contact center for its aggregate performance. Preferably, such thresholds will include, but are not limited to, a value indicative of an unacceptable level of problem calls, CSR performance or interaction dissatisfaction per week.

Thus, a computer program of one embodiment of the present invention aggregates the performance data for at least two interactions. A macro indicator value is then assigned to the aggregated performance data for an identified performance area. The computer program also receives an input transmission, via known input methods, of a macro threshold for the aggregated performance data for the identified performance area. The macro indicator value for the aggregated performance data is then compared to the macro threshold, and macro performance data is generated from the comparison. Similar to the first indicator value, the macro indicator value can include, but is not limited to, a score, the occurrence of an event, the frequency of an occurrence of an event, or any other measure of the aggregated generated performance data. It is understood that the macro indicator value will reflect a performance standard for the interactions in the aggregate, rather than a performance standard for an individual interaction. As with the analysis of individual interactions, the computer program of this embodiment is configured to generate an alert, in this case a macro alert, when the assigned macro indicator value is equal to or greater than the macro threshold as well as a corresponding macro action ticket when a macro alert is generated.

According to one embodiment, the present computer program identifies at least two discrete time periods for analysis. The computer program then analyzes one or more of the macro performance data, the generated macro alerts, and the generated macro action tickets for the selected time periods for identified time periods. From that analysis, the computer program generates macro trend data. It is further contemplated that either or both a hard copy report illustrating macro trend data, and an output viewable via a GUI can be generated by the present computer program. Additionally, the output may be in the form of a graphic representation of each macro alert and macro action ticket generated for the interactions received by a contact center for an identified time period; as well as the reason the macro alerts and macro action tickets were generated.

It is often desirable to analyze the aggregate performance effectiveness of a contact center on a macro scale for discrete time periods. For example, it may be desirable to aggregate, for a plurality of discrete time periods, all the macro alerts generated for a contact center. The aggregated macro alerts can be mined for common attributes and generate trend data. It is contemplated that one or both of a report comprising the macro trend data and a graphical user interface adapted to the display the macro trend data is generated. Preferably, in an embodiment of the present invention, a report will include a graph plotting each macro alert and macro action ticket generated for the interactions received by a contact center for an identified time period and the reason the macro alert and macro action ticket were generated.

As discussed above, assessment data is generated from an enhanced assessment of the resultant trend data. More particularly, assessment data determines the underlying factors driving the trends reflected in the trend data. With respect to macro assessment data, analysis is performed at a macro level to determine the causation of larger trends in the business methods of contact centers.

It should be understood that while the above embodiment describes a method and system for monitoring an identified performance area for a contact center by receiving analytics from a plurality of interactions, the present invention may also be employed to receive analytics from a single interaction.

While the specific embodiments have been illustrated and described, numerous modifications come to mind without significantly departing from the spirit of the invention and the scope of protection is only limited by the scope of the accompanying Claims.

What is claimed is:

1. A computer readable medium adapted to control a computer and comprising a plurality of code segments for automatically monitoring an identified performance area for a contact center, the computer readable medium comprising:
a code segment for identifying a performance area comprising at least one of human activity-based performance, caller dissatisfaction performance, problem call performance, customer service representative performance, business process performance, self service performance and peer comparison performance;
a code segment for receiving an input transmission of a threshold for the identified performance area;
a code segment for receiving analytics generated for each of a plurality of interactions received by a contact center;
a code segment for selecting from the received analytics, for each of the plurality of interactions, the analytics that correspond to the identified performance area;
a code segment for assigning an indicator value, for each of the plurality of interactions, to the selected analytics for the identified performance area;
a code segment for comparing the indicator value to the threshold and generating performance data therefrom for each of the plurality of interactions;
a code segment for generating an alert when the assigned indicator values is equal to or exceeds the threshold.

2. The computer readable medium of claim 1, wherein the received analytics is based on at least one of voice data and IVR inputs.

3. The computer readable medium of claim 1, wherein the threshold is dynamically adjusted based on the generated performance data.

4. The computer readable medium of claim I further comprising:
a code segment for analyzing at least one of the performance data and the generated alert for at least two of the plurality of interactions and generating trend data; and
a code segment for generating at least one of a report comprising the trend data and a graphical user interface adapted to display the trend data.

5. The computer readable medium of claim 4, further comprising a code segment for generating assessment data based on the trend data.

6. The computer readable medium of claim 5, wherein generating assessment data further comprises generating at least one of a report comprising the assessment data and a graphical user interface adapted to display the assessment data.

7. The computer readable medium of claim 1, further comprising a code segment for generating an action ticket when an alert is generated.

8. The computer readable medium of claim 1, further comprising a code segment for generating a graphical user interface adapted to display at least one of the generated alert and the generated performance data.

9. A computer readable medium adapted to control a computer and comprising a plurality of code segments for automatically monitoring an identified performance area on a macro scale for a contact center, the computer readable medium comprising:
a code segment for identifying a performance area comprising at least one of human activity-based performance, caller dissatisfaction performance, problem call performance, customer service representative performance, business process performance, self service performance and peer comparison performance;
a code segment for receiving an input transmission of a first threshold for the identified performance area;
a code segment for receiving analytics generated for each of a plurality of interactions received by a contact center;
a code segment for selecting from the received analytics, for each of the plurality of interactions, the analytics that correspond to the identified performance area;
a code segment for assigning a first indicator value, for each of the plurality of interactions, to the selected analytics for the identified performance area;
a code segment for comparing the first indicator value to the first threshold and generating performance data therefrom for each of the plurality of interactions;
a code segment for aggregating the performance data for at least two of the plurality of interactions and assigning a macro indicator value to the aggregated performance data for an identified performance area;
a code segment for receiving an input transmission of a macro threshold for the aggregated performance data for the identified performance area;
a code segment for comparing the macro indicator value for the aggregated performance data to the macro threshold and generating macro performance data therefrom; and
a code segment for generating a macro alert when the assigned macro indicator value is equal to or exceeds the macro threshold.

10. The computer readable medium of claim 9, wherein the received analytics is based on at least one of voice data and IVR inputs.

11. The computer readable medium of claim 9, wherein the macro threshold is dynamically adjusted based on the macro performance data.

12. The computer readable medium of claim 9 further comprising:
a code segment for identifying at least two discrete time periods;
a code segment for analyzing at least one of the macro performance data and the generated macro alerts for identified time periods and generating macro trend data; and
a code segment for generating at least one of a report comprising the macro trend data and a graphical user interface adapted to display the macro trend data.

13. The computer readable medium of claim 9, further comprising a code segment for generating macro assessment data based on the macro trend data.

14. The computer readable medium of claim 13, wherein generating macro assessment data further comprises generating at least one of a report comprising the macro assessment data and a graphical user interface adapted to display the macro assessment data.

15. The computer readable medium of claim 9, further comprising a code segment generating a macro action ticket when a macro alert is generated.

16. The computer readable medium of claim 10, further comprising a code segment for generating a graphical user interface adapted to display at least one of the generated macro alert and the generated macro performance data.

17. A computer readable medium adapted to control a computer and comprising a plurality of code segments for automatically monitoring an identified performance area for a contact center, the computer readable medium comprising:
a code segment for identifying a performance area comprising at least one of human activity-based performance, caller dissatisfaction performance, problem call performance, customer service representative performance, business process performance, self service performance and peer comparison performance;
a code segment for receiving an input transmission of a threshold for the performance area;
a code segment for receiving analytics generated for an interaction received by a contact center;
a code segment for selecting the received analytics that correspond to the performance area;
a code segment for assigning an indicator value to the selected analytics for the performance area;
a code segment for comparing the indicator value to the threshold and generating performance data therefrom; and
a code segment for generating an alert when the assigned indicator values is equal to or exceeds the threshold.

18. The computer readable medium of claim 17, further comprising a code segment for generating an action ticket when an alert is generated.
